(19) United States
(12) Patent Application Publication
(10) Pub. No.: US 2012/0286112 A1
(43) Pub. Date: Nov. 15, 2012

(54) MOTOR SHIPPING CLIP

(75) Inventors: Robert M. Wolford, Rockford, MI (US); Steve O. Mork, Lowell, MI (US)

(73) Assignee: Access Business Group International LLC, Ada, MI (US)

(21) Appl. No.: 13/467,303

(22) Filed: May 9, 2012

Related U.S. Application Data
(60) Provisional application No. 61/484,696, filed on May 11, 2011.

(51) Int. Cl. F16M 13/02; B23P 11/00

(52) U.S. Cl. 248/205.1; 29/428

(57) ABSTRACT

A shipping clip is provided that includes at least one finger extending between portions of the rotor and stator to prevent unwanted movement therebetween. The finger may extend from a base portion, and the base portion may be configured to attach to a particular structure on the motor. For example, the base portion may include a receptacle that receives a mounting post on the motor, and the finger may extend from the base to fit between a ledge on the stator and the upper surface of the rotor. The finger prevents further insertion of the stator into the rotor.

### BACKGROUND OF THE INVENTION

The present invention relates to the shipment of electric motors, and, more particularly, to a shipping clip for preventing unwanted movement between the rotor and stator of an electric motor during shipment.

In general, an electric motor includes a stationary element, known as a stator, and a rotating element, known as a rotor. When a current is provided to the motor, the rotor rotates with respect to the stator about an axis. In the particular case of an electric blower motor, the stator may be positioned inside the rotor, and the rotor may include integral fan blades, such that when the motor is activated, the rotor and fan blades rotate to cause a desired air flow.

An internal bearing system, such as a ball bearing system or a sleeve bearing system, is typically provided between the stator and rotor to enable smooth, quiet rotation of the rotor during operation of the motor. The bearing system maintains the proper radial positioning of the rotor with respect to the stator, to prevent unwanted contact or movement between the rotor and stator. The bearing system generally does not, however, restrict or prevent axial movement of the rotor with respect to the stator.

It is common for electric blower motors to be mounted within the housing of an air treatment system, or another type of system, for drawing air through the housing and through the components of the air treatment system. As such, electric blower motors often include mounting posts or other hardware for use in mounting the motor into the air treatment system housing. The housing may be specifically designed to receive the motor, and to prevent movement of the motor (other than the rotation of the rotor) within the housing when the motor is mounted within the housing. In many cases, the axial movement of the rotor with respect to the stator is often restricted by the housing when the motor is mounted into the housing. As a result, the rotor and stator may move axially with respect to each other at any time prior to the installation of the motor into the housing, potentially causing damage to portions of the rotor and/or stator due to unwanted axial movement and unwanted contact between these elements.

### SUMMARY OF THE INVENTION

The aforementioned problems are overcome by the present invention wherein a shipping clip prevents unwanted axial movement between the stator and the rotor of an electric motor.

In one embodiment, a shipping clip is provided that includes at least one finger extending between portions of the rotor and stator to prevent unwanted movement therebetween. The finger may extend from a base portion, and the base portion may be configured to attach to a particular structure on the motor. For example, the base portion may include a receptacle that receives a mounting post on the motor, and the finger may extend from the base to fit between a ledge on the stator and the upper surface of the rotor. The finger prevents further insertion of the stator into the rotor.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein.

Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of an electric motor and shipping clip according to one embodiment of the present invention.

FIG. 2 is an exploded view of the motor and shipping clip.

FIG. 3 is a side cross sectional view of the motor and shipping clip.

FIG. 4 is a top view of the shipping clip.

FIG. 5 is a side view of the shipping clip.

FIG. 6 is a bottom view of the shipping clip.

FIG. 7 is a perspective view of the shipping clip.

FIG. 8 is an end view of the shipping clip.

FIG. 9 is a perspective view of a shipping clip according to a second embodiment.

### DESCRIPTION OF THE CURRENT EMBODIMENT

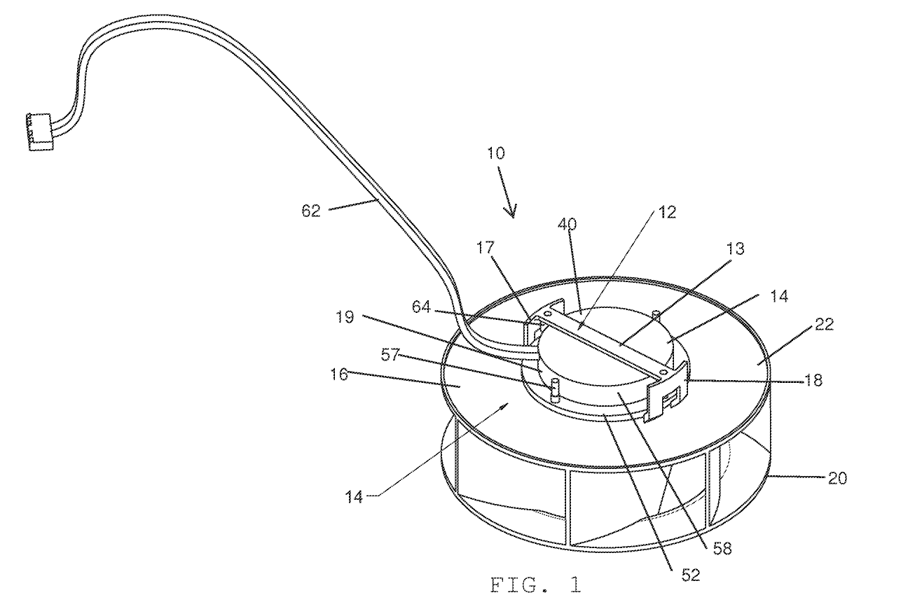

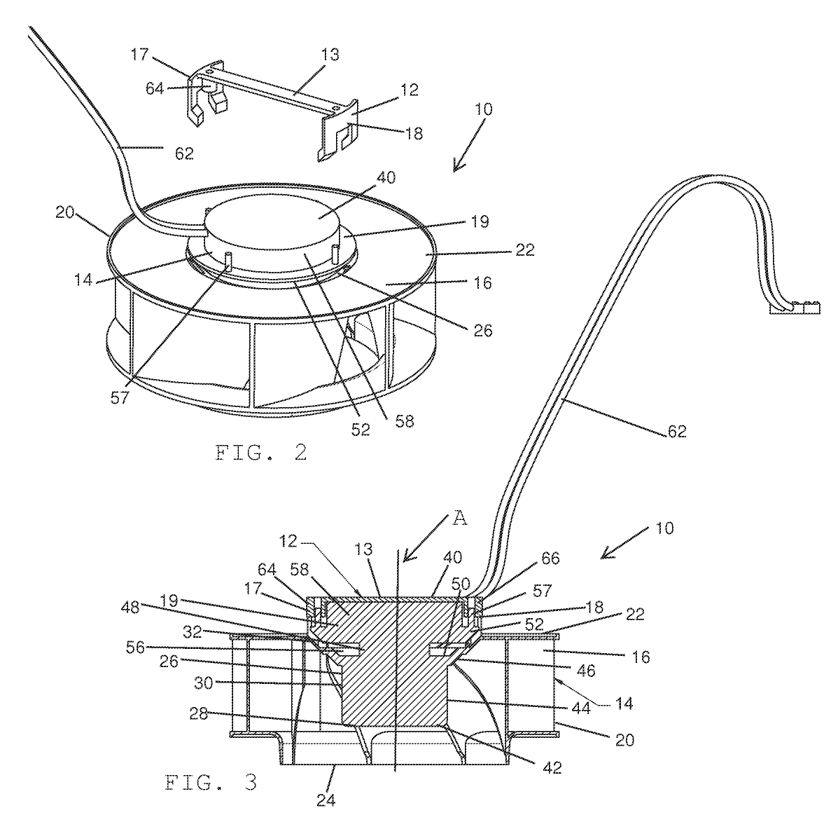

A motor and shipping clip assembly according to one embodiment of the present invention is shown in FIGS. 1-3 and generally designated 10. In the illustrated embodiment, the shipping clip 12 includes a base 13 that attaches to a portion of the motor 14, and a pair of fingers 17, 18 that extend from the base 13. The fingers extend from the base 13 to fit between a portion of the rotor 16 and a portion of the stator 19 to prevent unwanted axial movement of the rotor 16 with respect to the stator 19.

The motor 14 is a generally conventional electric motor, and therefore will not be described in detail. As illustrated, the motor includes a stator 19 and a rotor 16. In its final use, the stator 19 is affixed to the housing (not shown) of a system, such as an air treatment system, and the rotor 16 rotates about the stator 19 when a current is applied to the motor 14. In one embodiment, the rotor 16 is external to the stator 19 and the rotor 16 includes fan blades spaced apart about the circumference of the rotor 16. The rotor 16 is generally cylindrical in shape, and includes an outer surface 20, an upper surface 22, and a lower surface 24. The rotor 16 has a width extending between the upper 22 and lower 24 surfaces. The rotor 16 further includes a bore 26 extending along the central axis A of the motor 14 through a portion of the width of the rotor 16. As shown, the bore 26 includes a floor 28, a cylindrical portion 30 extending from the floor 28, and a frustoconical portion 32 extending from the cylindrical portion 30 to the upper surface 22.

In the illustrated embodiment, the stator 19 is configured to be inserted into the bore 26 of the rotor 16 along the central axis A of the motor 14. As shown, the stator 19 includes an upper surface 40 and a lower surface 42. The stator 19 includes a cylindrical portion 44 sized with a diameter slightly smaller than the diameter of the cylindrical portion 30 of the bore 26 in the rotor 16, and a first frustoconical portion 46 sized to fit within the frustoconical portion 32 of the bore 26. A neck 48 extends from the upper surface 50 of the first frustoconical portion 46 having a diameter smaller than the diameter of the cylindrical portion 44. A second frustoconical portion 52 extends from the upper edge of the neck 48, forming a gap 56 between the first 46 and second 52 frustoconical portions. A cylindrical head 58 extends upwardly from the upper surface 60 of the second frustoconical portion 52 having a diameter greater than the cylindrical portion 44 and the neck 48, but smaller than the diameter of the second frustoconical portion 52. Four mounting posts 57 extend upwardly from the upper surface 60 of the second frustoconical portion 52. The mounting posts 57 are spaced apart evenly about the cylindrical head 58, and in the illustrated embodiment extend upwardly to a height that is less than the height of the cylindrical head 58, although the height and spacing of the mounting posts may vary from application to application. An electrical wire 62 capable of supplying an electrical current to the motor 14 extends into the head 58. The external shape of the stator may vary; however, the stator generally includes at least one portion about which the rotor 16 rotates, such that the rotor 16 rotates about the axis A when a current is provided to the motor 14.

The shipping clip 12 may be made from a variety of materials, and in one embodiment is made from a resilient material such as rubber or a thermoplastic elastomer. Other plastics and metals may be used provided that they are sufficiently flexible to enable the shipping clip 12 to be flexed to attach the clip 12 to the motor 14 with the fingers 17, 18 positioned as desired. In one embodiment, the shipping clip 12 is made from a bright colored material in order to make the shipping clip 12 highly visible to manufacturers at the point of installation into the system housing in order to prevent attempted installation of the motor 14 into the system housing before removing the shipping clip 12.

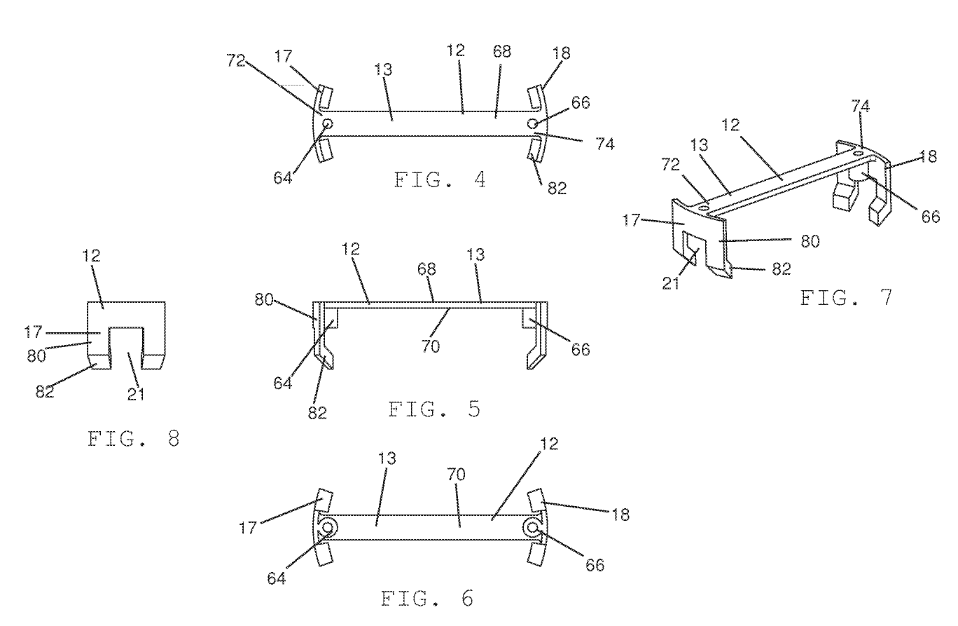

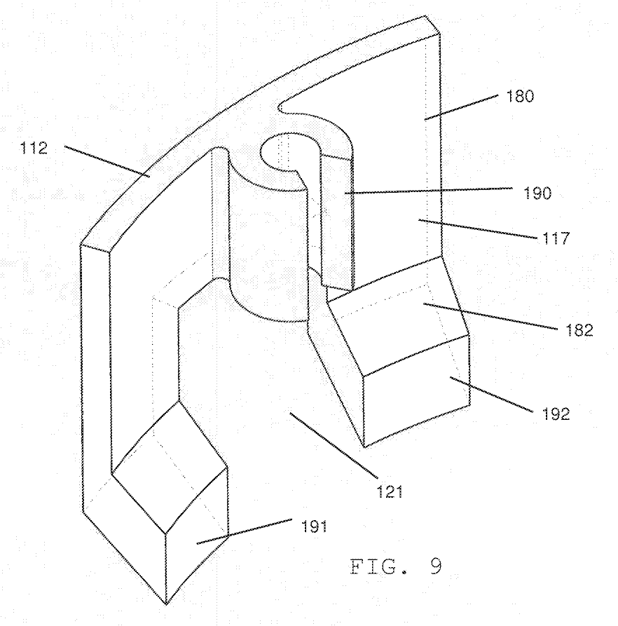

In the embodiment illustrated in FIGS. 1-8, the shipping clip 12 includes a base 13, a pair of receptacles 64, 66, and a pair of fingers 17, 18. The base 13 is a generally elongated strap having an upper surface 68, a lower surface 70 opposite the upper surface 68, a first end 72 and a second end 74 opposite the first end 72. In the illustrated embodiment, the length of the base 13 between the first 72 and second 74 ends is approximately the same as the diameter of the second frustoconical portion 52 of the stator 19. The first finger 17 extends downwardly from the lower surface 70 of the base 13 at the first end 72, and the second finger 18 extends downwardly from the lower surface 70 of the base 13 at the second end 74. Each finger 17, 18 includes a first portion 80 extending from the base 13 approximately perpendicular to the base 13, and a second portion 82 extending from the first portion 80. The second portion 82 angles inwardly from the first portion 80 such that the second portions 80 of the arms 17, 18 converge toward each other. In the illustrated embodiment, each finger 17, 18 includes a cutout 21 extending into the second portion 82 and partially into the first portion 80 to form a forked end on each finger 17, 18. Referring to FIGS. 4, 6 and 7, when viewed from above, each finger may be curved to have an arc shape that matches the shape of the arc shape of the second frustoconical portion 52 of the stator 16.

A pair of generally cylindrical receptacles 64, 66 extend downwardly from the lower surface 70 of the base 13. The first receptacle 64 is positioned adjacent to the finger 17 at the first end 72 of the strap 13. The second receptacle 66 is positioned adjacent to the finger 18 at the second end 74 of the strap 13. As shown, the receptacles 64, 66 are spaced from each other at the same distance as the distance between diametrically opposing posts 57, and the receptacles 64, 66 are sized so that each receptacle 64, 66 is capable of receiving one of the posts 57.

The shipping clip 12 is installed on the motor 14 before the motor 14 is installed in the system housing. In one embodiment, the shipping clip 12 is installed on the motor 14 prior to shipping the motor 14 for installation into the final system housing. The shipping clip 12 is installed onto the motor 14 by flexing the fingers 17, 18 outwardly such that the second portion 82 of the fingers 17, 18 clears the diameter of the second frustoconical portion 52. The shipping clip 12 is moved towards the upper surface of the stator head 58 until two of the mounting posts 57 extend into the receptacles 64, 66. The fingers 17, 18 are then released such that they flex back to their original position, whereby the second portions 82 of the fingers extend underneath a portion of the second frustoconical portion 52 of the stator 19. The length and angle of the fingers 17, 18 are predetermined such that the fingers fit against the ramped surface of the second frustoconical portion 52. The shipping clip 12 may be attached to the stator before the stator 19 is inserted into the rotor 16, or the shipping clip 12 may be attached to the stator 19 by partially removing the stator 19 from the rotor 16 to insert the shipping clip 12. In either case, the second portion 82 of the fingers 17, 18 engages the frustoconical portion 32 of the rotor 16 when the stator 19 is inserted into the bore 26 of the rotor 16 to prevent further insertion of the stator 19 into the bore 26 along the axis A. Alternatively, at least a portion of the fingers 17, 18 may extend underneath a different portion of the stator 19 to engage a different portion of the rotor 16 to prevent further axial insertion of the stator 19 into the rotor 16.

The shipping clip 12 remains on the motor 14 until the motor has been shipped and is ready for installation into the final system housing. In this way, the shipping clip 12 may prevent damage caused by unwanted axial movement and contact between the rotor 16 and stator 19 during shipment. The attachment of the shipping clip 12 to the mounting posts 57 on the stator 19 acts as a poka-yoke to prevent installation of the motor 14 into the housing without removing the shipping clip 12, because the mounting posts 57 cannot fit properly into the housing when the shipping clip 12 is attached. Thus, the installer removes the shipping clip 12 by flexing the fingers 17, 18 outwardly and pulling the base portion from the mounting posts 57 prior to installing the motor 14 in the housing.

An alternative embodiment of the shipping clip 112 is shown in FIG. 9. In the FIG. 9 embodiment, the shipping clip 112 generally includes a receptacle 190 and a finger 117 extending from the receptacle 190. The receptacle 190 is generally C-shaped in cross section, and sized to receive one of the mounting posts 57 on the motor 14. The finger 117 is generally the same as one of the fingers 17, 18 of the first embodiment, such that the finger 117 includes a first portion 180 extending from the receptacle such that the first portion 180 is parallel to the axis of the receptacle 190, a section portion 182 that extends on an angle from the first portion in the direction of the receptacle 190, and a cutout 121 extending into the first 180 and second 182 finger portions to form a forked end with two elements 191, 192 that can flex independently of one another. Alternatively, the receptacle 190 may have a different cross sectional shape, for instance, the receptacle may be cylindrical or square in cross sectional shape and sized to receive one of the posts 57. Operation of the shipping clip 112 is similar to the operation of the shipping clip 12, in that the receptacles receive the mounting posts 57 on the stator 19 and the fingers 117, 118 extend underneath a portion of the stator 19 to prevent unwanted insertion of the stator 19 into the bore 26 in the rotor 16.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to packages of any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A clip for protecting a rotor and a stator during shipping of a motor comprising:
a base for extending over an end of the stator;
at least one finger extending from the base including a first portion extending from the base and a second portion extending from the first portion, the second portion adapted to fit between at least a portion of the rotor and at least a portion of the stator to prevent axial movement between the rotor and the stator prior to final installation of the rotor and the stator.

2. The clip of claim 1 including at least one receptacle extending from the base for receiving a mounting post extending from the motor.

3. The clip of claim 2 wherein the second portion is angled with respect to the first portion.

4. The clip of claim 3 including a cutout defined in an end of the finger, the cutout forming a forked finger.

5. The clip of claim 4 wherein the finger has an arc shape when viewed from a top surface of the base.

6. The clip of claim 5 wherein the base is a generally elongated strap.

7. The clip of claim 6 wherein at least a portion of the clip has a highly visible bright color for preventing final installation of the rotor and stator before removing the clip.

8. A motor shipping assembly comprising:
a rotor;
a stator corresponding to the rotor, the stator including at least one mounting post;
a clip having at least one finger positioned between at least a portion of the rotor and at least a portion of the stator to prevent axial movement of the rotor with respect to the stator during shipping, the clip including at least one receptacle receiving the at least one mounting post.

9. The motor shipping assembly of claim 8 wherein the clip is adapted to prevent final installation of the rotor and stator without removing the clip.

10. The motor shipping assembly of claim 8 wherein the finger includes a first portion and a second portion, the first portion extending approximately parallel to an axis of the motor, the second portion extending at an angle relative to the axis of the motor.

11. The motor shipping assembly of claim 10 wherein the clip includes a base extending over an end of the stator, the base connected to the at least one finger and the at least one receptacle.

12. The motor shipping assembly of claim 11 wherein the finger defines a cutout in an end of the finger, the cutout forming a forked finger.

13. The motor shipping assembly of claim 12 wherein the stator has an upper surface defining a first height and wherein the at least one mounting post defines a second height, the second height being less than the first height.

14. The motor shipping assembly of claim 13 wherein the rotor includes a bore having a rotor frustoconical portion and the stator has a stator frustoconical portion, the at least one finger extending between at least a portion of the rotor frustoconical portion and at least a portion of the stator frustoconical portion.

15. The motor shipping assembly of claim 14 wherein the finger and the stator frustoconical portion each have an arc shape when viewed along the axis of the motor, the arc shape of the finger approximately matching the arc shape of the stator frustoconical portion.

16. The motor shipping assembly of claim 15 wherein the rotor includes fan blades spaced apart about a circumference of the rotor.

17. The motor shipping assembly of claim 16 wherein the clip is made of a sufficiently flexible material to allow the clip to be flexed and inserted over the end of the stator.

18. A method for installing a protective clip on a motor comprising:
providing the clip with a base and at least two fingers extending from the base;
flexing the clip to allow the at least two fingers to fit around a head of a stator;
moving the clip towards an upper surface of the stator head until at least one mounting post extending from the motor extends into at least one corresponding receptacle included in the clip; and
relaxing the clip to allow the fingers to flex back to their original position and to allow a portion of the fingers to fit around at least a portion of the stator.

19. The method of claim 18 wherein the relaxing the clip step includes allowing a portion of the fingers to extend underneath at least a portion of a frustoconical portion of the stator.

20. The method of claim 19 including removing the clip from the stator prior to installation of the stator in a housing.
